(19) United States
(12) Patent Application Publication
(10) Pub. No.: US 2025/0381654 A1
(43) Pub. Date: Dec. 18, 2025

(54) Gasket Installation Guide

(71) Applicant: Tim Fleet, Atoka, TN (US)

(72) Inventor: Tim Fleet, Atoka, TN (US)

(21) Appl. No.: 19/315,598

(22) Filed: Aug. 31, 2025

Related U.S. Application Data
(62) Division of application No. 19/001,885, filed on Dec. 26, 2024.
Application No. 19/001,885 is a continuation-in-part of application No. 17/480,995, filed on Sep. 21, 2021, now abandoned.

(51) Int. Cl. B25B 27/00; F16L 21/03

(52) U.S. Cl. CPC B25B 27/0028; F16L 21/03

(57) ABSTRACT

A gasket installation guide and method of use wherein the gasket installation guide is used to aid in the insertion of gaskets into flair connector comprising a body that is inserted into the flair connector to align the center hole that passes through the body with the female flare fitting of the flair connector, so that the gasket can be easily installed.

### CROSS-REFERENCE TO RELATED APPLICATIONS

| | | |
|---|---|---|
| 17,480,995 | Fleet | Sep. 21, 2021 |
| 19,001,885 | Fleet | Dec. 26, 2024 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

A gasket installation guide used to aid in the installation of a gasket into the joint between a female flare fitting and a service hose, and storage device for the gaskets.

### Background of the Invention

This application a continuation-in-part of U.S. patent application Ser. No. 19,001,885 filed Dec. 26, 2024, and U.S. patent application Ser. No. 19,001,885 is a continuation-in-part of U.S. patent application Ser. No. 17,480,995 filed Sep. 21, 2021. The benefit of the earlier filing dates of the aforementioned U.S. patent application Ser. Nos. 19,001,885 and 17,480,995 is hereby claimed.

In order to properly connect a male flare fitting on a piping system to a female flare fitting of a hose, a sealing gasket or gasket is used in the female flare fitting to complete the seal. The confined space of a female flare fitting makes it difficult to insert a gasket into the opening at the bottom of the female flare fitting. Specifically, the female flare fitting frequently has a non-retractable internally threaded sleeve that protrudes above the opening into which the gasket needs to be inserted. The non-retractable sleeve obstructs the access to the opening, making it difficult to insert the gasket into the opening. The present disclosure aids in the installation of a gasket into a female flare fitting by allowing the body of the gasket installation device to be inserted into the sleeve of the female flare fitting, and having a shaft through the gasket installation device directly to the opening where the gasket is to be inserted. The sphero-conical shape of the shaft also causes the gasket to be slightly compressed prior to insertion, further simplifying the installation process. Extending the gasket slightly beyond the bottom of the gasket installation guide further aids in the alignment of the gasket with the female flare fitting. With this useful and proper positioning of the gasket in the gasket installation guide and the gasket installation guide properly inserted into the sleeve of the female flare fitting, a push rod is used to push the gasket into place in the opening of the female flare fitting. Then the gasket installation guide can then be slid out from the sleeve of the female flare fitting, to complete the gasket's insertion. In one embodiment of the gasket installation guide, the push rod also acts as a storage container for gaskets, whereby the handle of the push rod is itself hollow, and possesses an upper segment and a lower segment, and the upper segment is threadedly attached to the lower segment, to allow for the hollowed-out portion of the handle to be accessed so that gaskets may be stored within.

### SUMMARY OF THE INVENTION

The present disclosure reveals a gasket installation guide to aid in the insertion a gasket into a female flare fitting of a hose connection as well as a method of use of the gasket installation guide. The gasket installation guide consists of a body with a tapered shaft passing though the body and a pushrod that facilitates the movement of the gasket through and out of the shaft. At the bottom end of the body, the shero-conical shaft is the same diameter as the interior diameter of the female flare fitting into which the gasket will be inserted. At the top of the body of the gasket installation guide, the diameter if the shaft is larger than the diameter of the gasket for easy insertion of the gasket into the body. The shaft is tapered towards the end that aligns with the female flare fitting to reduce the diameter of the gasket to slightly smaller than the female flare fitting into which the gasket will be inserted. When the lower portion of the body of the guide is inserted into the sleeve of the flare hose connection, the shaft aligns with the opening of the female flare fitting into which the gasket will be inserted. Once the body is positioned and the shaft is aligned, the pushrod is used to push the gasket into place. Having the gasket protrude beyond the end of the gasket installation guide further aids in the alignment of the gasket installation guide with the female flare fitting. In one embodiment of the gasket installation guide, the push rod also acts as a storage container for gaskets, whereby the handle of the push rod is itself hollow, and possesses an upper segment and a lower segment, and the upper segment is threadedly attached to the lower segment, to allow for the hollowed-out segment of the handle to be accessed so that gaskets may be stored within.

### BRIEF DESCRIPTION OF THE SEVERAL VIEWS OF THE DRAWING

FIG. 1 is an image of a female flare fitting with identification of the relevant parts of the female flare fitting to aid in understanding the novelty of the invention;

FIG. 2 is an image of a gasket installation guide including body and pushrod;

FIG. 3 is an image of the body of the gasket installation guide including the upper portion, the lower portion, an indication of the location of the shaft through the body, and threading on the lower portion;

FIG. 4 is a cross section of the gasket installation guide showing the taper of the shaft;

FIG. 5A is an image the pushrod including a grip;

FIG. 5B is an image of the pushrod including a loop for a handle;

FIG. 5C is an image of the pushrod including the grip and a loop for a handle;

FIG. 6 is an image of the Gasket Installation Guide with the push rod and body aligned with a female flare fitting to insert a gasket; and

FIG. 7 is an image of the push rod of the gasket installation guide wherein the handle comprises an upper segment and a lower segment, the lower segment being hollowed-out and the upper segment is threadedly attached to the lower segment in order to access the hollowed-out segment of the lower segment, so that gaskets can be stored inside.

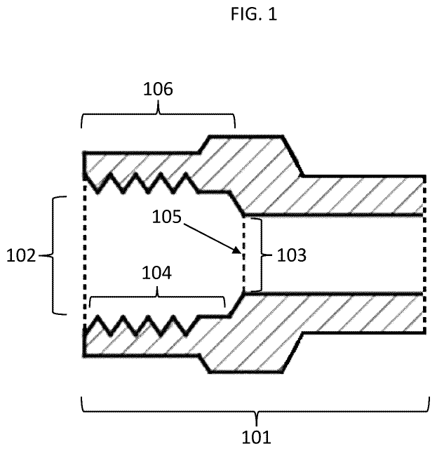

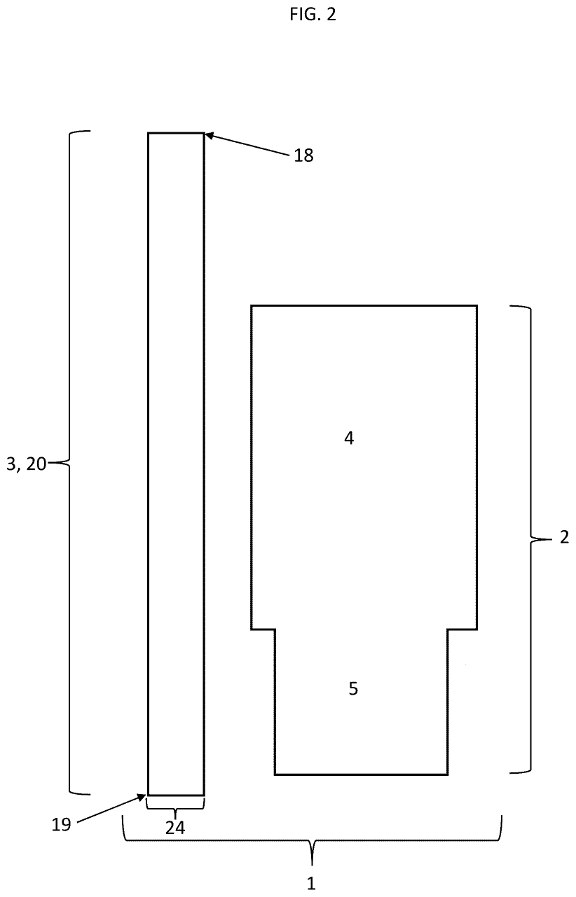

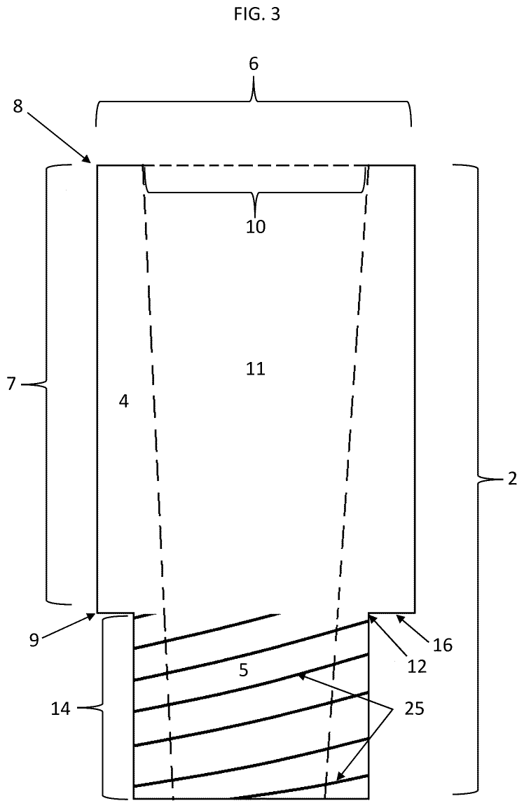

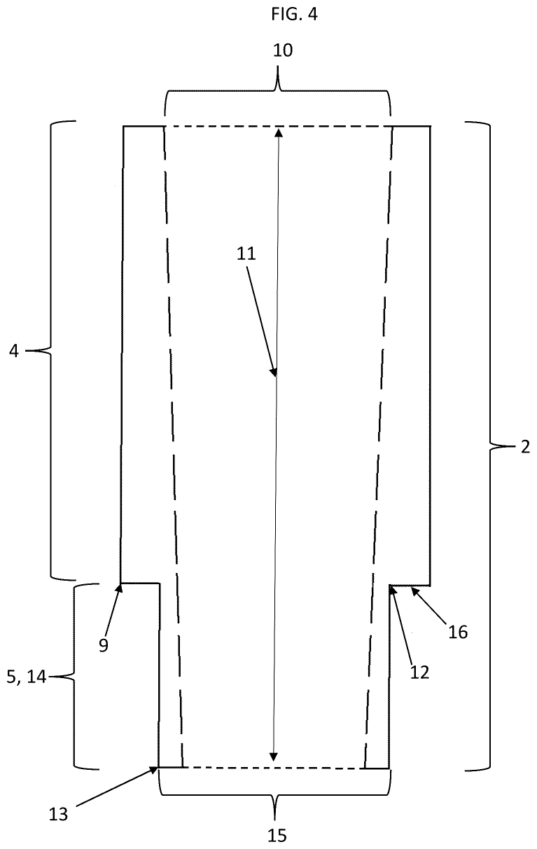

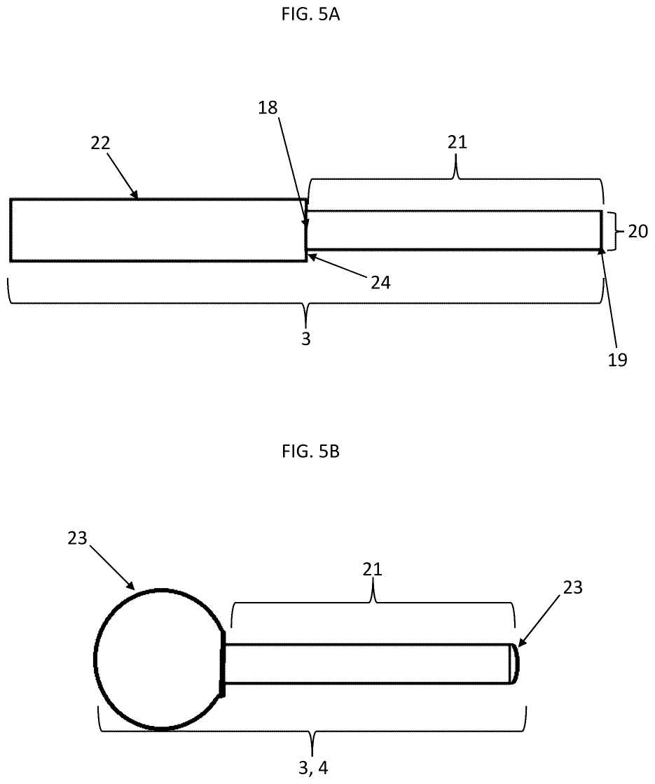

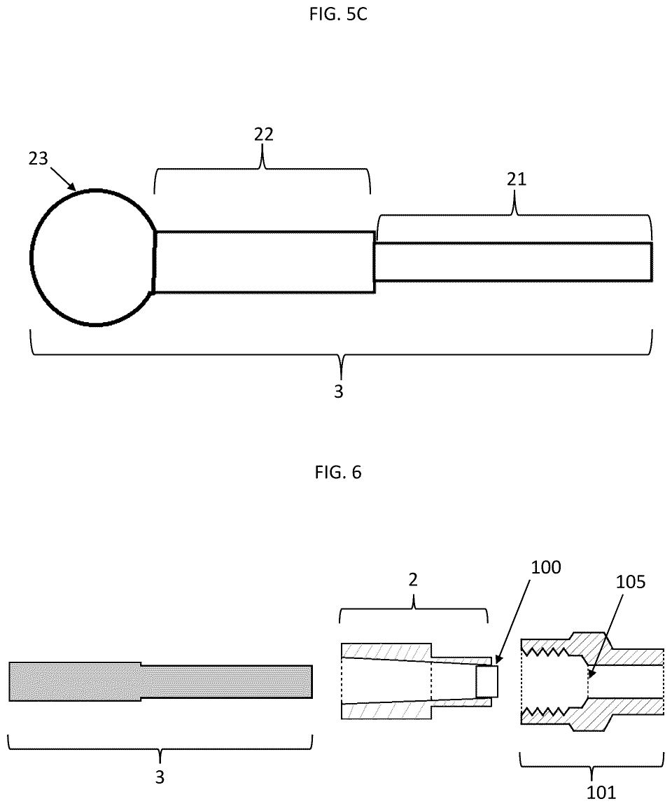

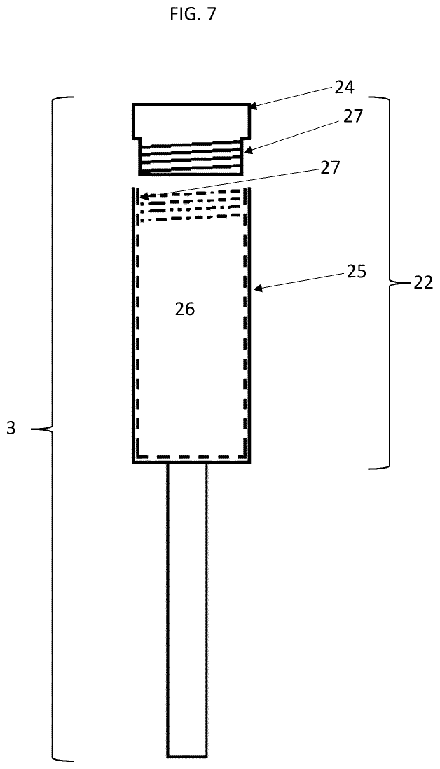

### DETAILED DESCRIPTION OF THE INVENTION

The present disclosure reveals a gasket installation guide 1 to aid in the insertion of a gasket 100 into a female flare fitting 101 of a flare hose connector.

A female flare fitting 101 for a flare hose connector comprises a thread diameter 102, an inner diameter 103, a thread depth 104, a prospective gasket placement location 105, and a sleeve 106.

said gasket installation guide 1 comprising a body 2 and a pushrod 3. The body 2 and pushrod 3 being made from at least one of plastic, iron, steel, aluminum, copper, brass, nickel, or wood.

The body 2 consists of an upper portion 4 and a lower portion 5. The upper portion 4 comprising of an outer diameter 6, a height 7, a top 8, a lower edge 9, and a center hole 10. The outer diameter 6 of the upper portion 4 is larger than the inner diameter of the female flare fitting 101 into which the gasket installation guide 1 is to be inserted.

The lower portion 5 of the gasket installation guide 1 comprises an upper edge 12, a bottom 13, a depth 14, and an outer diameter 15. The lower portion 5 extends out from the lower edge 9 of the upper portion 4 to the bottom 13 of the lower portion 5. The outer diameter 15 matches the thread diameter 102 of the female flare fitting 101, so as to allow the lower portion 5 to be inserted into the female flare fitting 101. The depth 14 of the lower portion 5 is at least the thread depth 104 of the female flare fitting 101. There is a taper 16 between the lower edge 9 of the upper portion 4 to the upper edge 12 of the lower portion 5.

The center hole 10 is located in the center of the top 8 of the upper portion 4, consists of a shaft 11 that extends perpendicularly through the upper portion 4 and the lower portion 5 and is sphero-conical from the top 8 of the upper portion 4 to the bottom 13 of the lower portion 5. At the top 8 of the upper portion 4, the diameter 17 of the center hole 10 of the shaft 11 is larger than the inner diameter 103 of the female flare fitting 101 into which the gasket 100 is to be inserted but not so large as to allow the allow the gasket 100 to rotate within the shaft 11. The shaft 11 tapers from the top 9 of the upper portion 4 to the bottom 13 of the lower portion 5 and is designed to slightly compress the gasket prior to insertion so as to make insertion into the female flare fitting 101 easier.

The pushrod 3 possesses a cylindrical shape and comprises a first end 18, a second end 19, a diameter 20, and a length 21. The diameter 20 of the pushrod 3 is such that the pushrod 3 can pass through the entire depth 14 of the shaft 11 while still pushing the gasket 100. The length 21 of the pushrod 3 is greater than the depth 14 of the shaft 11 of the body 2 so as to allow for easy operating of the pushrod 3 into and through the shaft 11. The second end 19 of the pushrod may be flat 24, pointed 26, or a spherical dome 25.

The gasket installation guide 1 may further consist of a grip 21 on the pushrod 3, said grip 21 may include but not be limited to a thickening of the diameter of the pushrod near the first end.

The gasket installation guide 1 may further include a handle 22 near the first end 18 of the pushrod 3, said handle 22 to be in at least one of a loop or an extension.

The handle 22 of the push rod 3 may comprise an upper segment 24 and a lower segment 25, wherein at least one of the upper segment 24 and the lower segment 25 being hollow 26, and the upper segment 24 is threadedly attached 27 to the lower segment 25, so that when the upper segment 24 is detached from the lower segment, the hollow portion 26 is accessible, so that gaskets 100 are inserted therein. The upper segment 24 is then threadedly connected to the lower segment 25 to confine the gaskets within the hollow portion 26.

The gasket installation guide 1 may further consist of threading 23 on the lower portion 5 of the gasket installation guide 1 so that the gasket installation guide 1 can be screwed into the female flair fitting 101.

What is claimed:

1. A gasket installation guide to aid in the insertion of a gasket into a female flare fitting of a flare hose connector, said gasket installation guide comprising:
the gasket installation guide, comprising a body and a pushrod;
the body being made from at least one of plastic, iron, steel, aluminum, copper, brass, nickel, or wood;
the body pushrod being made from at least one of plastic, iron, steel, aluminum, copper, brass, nickel, or wood;
the body consisting of an upper portion, a lower portion;
the upper portion consists of an outer diameter, a height, a top, a lower edge, and a center hole;
the outer diameter of the upper portion is larger than the thread diameter of the female flare fitting into which the gasket installation guide is to be inserted;
the lower portion of the gasket installation guide consists of an upper edge, a bottom, a depth, and an outer diameter;
The outer diameter is the size of the inner diameter of the female flare fitting into which the gasket installation guide is to be inserted;
there is a taper that extends from the lower edge of the upper portion to the upper edge of the lower portion;
there is a shaft that begins at the center hole in the top of the upper portion, extends through the upper portion and the lower portion, and is sphero-conical, wherein the diameter of the center hole at the top of the upper portion is larger than the inner diameter of the female flare fitting into which the gasket is to be inserted but not so large as to allow the allow the gasket to rotate within the center hole, and the diameter of the shaft at the bottom of the lower portion is equal to the inner diameter of the flare fitting;
the pushrod is cylindrical, has a first end, a second end, a diameter, a length;
the diameter of the pushrod allows the pushrod to be extended though the length of the shaft while pushing the gasket through the end of the shaft at the bottom of the lower portion;
the second end of the pushrod is at least one of flat or a spherical dome; and
the length of the pushrod is greater than the length of the shaft so as to allow for easy operating of the pushrod into and out of the shaft.

2. The gasket installation guide of claim 1 further comprising a grip on the first end of the push rod.

3. The gasket installation guide of claim 1 further comprising a handle on the first end of the push rod.

4. The gasket installation guide of claim 1 further comprising a grip on the first end of the push rod and a handle attached to the grip at the end opposite the first end of the push rod.

5. The gasket installation guide of claim 3 wherein the handle further comprises an upper segment and a lower segment, said lower segment being hollow, and the upper segment is threadedly attached to the lower segment, so that when the upper segment is detached from the lower segment, the hollowed-out portion of the lower portion is accessible, so that gaskets are inserted therein;
the upper segment is then threadedly connected to the lower segment to confine the gaskets within the hollowed-out portion of the lower segment.

6. The gasket installation guide of claim 4 wherein the handle further comprises an upper segment and a lower segment, said lower segment being hollow, and the upper segment is threadedly attached to the lower segment, so that when the upper segment is detached from the lower segment, the hollowed-out portion of the lower portion is accessible, so that gaskets are inserted therein;
the upper segment is then threadedly connected to the lower segment to confine the gaskets within the hollowed-out portion of the lower segment.

7. The gasket installation guide of claim 1 further comprising threading on the upper portion of the gasket installation guide.

8. The gasket installation guide of claim 7 further comprising a grip on the first end of the push rod.

9. The gasket installation guide of claim 7 further comprising a handle on the first end of the push rod.

10. The gasket installation guide of claim 7 further comprising a grip on the first end of the push rod and a handle attached to the grip at the end opposite the first end of the push rod.

11. The gasket installation guide of claim 9 wherein the handle further comprises an upper segment and a lower segment, said lower segment being hollow, and the upper segment is threadedly attached to the lower segment, so that when the upper segment is detached from the lower segment, the hollowed-out portion of the lower portion is accessible, so that gaskets are inserted therein;
the upper segment is then threadedly connected to the lower segment to confine the gaskets within the hollowed-out portion of the lower segment.

12. The gasket installation guide of claim 10 wherein the handle further comprises an upper segment and a lower segment, said lower segment being hollow, and the upper segment is threadedly attached to the lower segment, so that when the upper segment is detached from the lower segment, the hollowed-out portion of the lower portion is accessible, so that gaskets are inserted therein;
the upper segment is then threadedly connected to the lower segment to confine the gaskets within the hollowed-out portion of the lower segment.
